(19) United States
(12) Patent Application Publication
(10) Pub. No.: US 2011/0182385 A1
(43) Pub. Date: Jul. 28, 2011

(54) METHOD AND APPARATUS FOR RELIABILITY-AIDED PRUNING OF BLIND DECODING RESULTS

(75) Inventors: Dung Ngoc Doan, San Diego, CA (US); Kibeom Seong, West New York, NJ (US); Hossein Bagheri, Kitchener (CA)

(73) Assignee: QUALCOMM INCORPORATED, San Diego, CA (US)

(21) Appl. No.: 12/846,377

(22) Filed: Jul. 29, 2010

Related U.S. Application Data
(60) Provisional application No. 61/230,086, filed on Jul. 30, 2009.

(51) Int. Cl. H04L 27/06

(52) U.S. Cl. 375/340

(57) ABSTRACT

Reliability metric(s), based on output of a decoder module, associated with each possible hypothesis associated with blind decoding are provided that aids a pruning process by rejecting unreliable CRC-passed hypotheses. In an aspect, a downlink control channel carries scheduling assignments and other control information. As location, size, and CRC masking associated with downlink control information are not known to a receiver, blind decoding over possible hypotheses may be performed. The complex structure of the downlink control channel blind decoding results in increasing false alarm(s). Intelligent rules for pruning the decoding results are employed so that unreliable CRC-passed hypotheses are rejected as a function of respective reliability metric.

### CROSS-REFERENCE

This application claims the benefit of U.S. Provisional Application Ser. No. 61/230,086, filed Jul. 30, 2009, entitled “RELIABILITY-AIDED PRUNING PDCCH BLIND DECODING RESULTS,” and assigned to the assignee hereof and the entirety of which is incorporated herein by reference.

### BACKGROUND

I. Field

The present disclosure pertain to wireless communication systems, and in particular, to improved random access procedures in wireless communication systems.

Wireless communication systems are widely deployed to provide various communication content such as voice, video, packet data, messaging, broadcast, etc. These wireless systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

Generally, a wireless multiple-access communication system can simultaneously support communication for multiple wireless terminals. Each terminal communicates with one or more base stations via transmissions on forward and reverse links. The forward link (or downlink) refers to the communication link from base stations to terminals, and the reverse link (or uplink) refers to the communication link from terminals to base stations. This communication link may be established via a single-in-single-out, multiple-in-signal-out or a multiple-in-multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into Nₛ independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In addition, base stations can communicate with mobile terminals over a downlink control channel to provide scheduling assignments and other control information to facilitate communicating with the base station. The base stations can transmit the control information according to a variety of formats, and the mobile terminals can be unaware of the format chosen by the base station. In this regard, mobile terminals can blindly decode transmissions sent over the control channel according to known formats. Because structure of the control channel can be complex, blind decoding can sometimes render improper results, or false alarms (e.g., by selecting the wrong hypothesis for decoding the control channel), where the decoding appeared to be proper. Currently, false alarm detection is based on verifying cyclic redundancy check (CRC) of a decoded packet. Thus, if data decoded using a decoding hypothesis passes CRC, it can be assumed the decoding hypothesis is correct. However, there may be cases where a decoding hypothesis that passes CRC is still not reliable.

### SUMMARY

The following presents a simplified summary in order to provide a basic understanding of some aspects of the disclosed aspects. This summary is not an extensive overview and is intended to neither identify key or critical elements nor delineate the scope of such aspects. Its purpose is to present some concepts of the described features in a simplified form as a prelude to the more detailed description that is presented later.

In accordance with one or more aspects and corresponding disclosure thereof, various aspects are described in connection with providing a reliability metric, based on output of a decoder module, associated with each possible hypothesis associated with blind decoding that aids a pruning process by rejecting unreliable CRC-passed hypotheses. More particularly, a Physical Downlink Control Channel (PDCCH) carries scheduling assignments and other control information. As location, size, and CRC masking associated with Downlink Control Information (DCI) are not known to a receiver (Rx), blind decoding over possible hypotheses (which could be more than 100) should be performed. The complex structure of PDCCH blind decoding results in increasing false alarm(s) (e.g., the wrong hypothesis selection rate); thus, design of intelligent rules for pruning the decoding results is desirable so that unreliable CRC-passed hypotheses are rejected as a function of respective reliability metric.

In one aspect, a method comprises: decoding control data according to a decoding hypothesis; verifying that the decoded control data satisfies a cyclic redundancy check (CRC) according to a CRC portion provided with the control data; and generating a reliability metric associated with the decoding hypothesis based at least in part on the decoded control data.

In another aspect, a wireless communications apparatus, comprises: at least one processor configured to: apply a decoding hypothesis to received control data; discern that the decoding applied control data satisfies a cyclic redundancy check (CRC) according to CRC information provided with the control data; and create a reliability metric associated with the decoding hypothesis based at least in part on applying the decoding hypothesis to the control data.

In accordance with another aspect, an apparatus, comprises: means for decoding control data according to a decoding hypothesis; means for verifying that the decoded control data satisfies a cyclic redundancy check (CRC) according to a CRC portion provided with the control data; and means for generating a reliability metric associated with the decoding hypothesis based at least in part on the decoded control data.

In yet another aspect, a computer program product, comprises: a computer-readable medium, comprising: code for causing at least one computer to apply a decoding hypothesis to received control data; code for causing the at least one computer to discern that the decoding applied control data satisfies a cyclic redundancy check (CRC) according to CRC information provided with the control data; and code for causing the at least one computer to create a reliability metric associated with the decoding hypothesis based at least in part on applying the decoding hypothesis to the control data.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a multiple access wireless communication system according to one embodiment;

FIG. 2 illustrates a block diagram of a communication system;

FIG. 3 illustrates a system that facilitates blindly decoding downlink communications in a wireless network based on determining reliability of decoding hypotheses;

FIG. 4 illustrates a methodology that creates and compares reliability metric for decoding hypotheses to select a hypothesis for decoding received data;

FIG. 5 illustrates a system that facilitates blindly decoding downlink communications in a wireless network based on determining reliability of decoding hypotheses;

FIG. 6 illustrates a system that facilitates blindly decoding downlink communications in a wireless network based on determining reliability of decoding hypotheses;

FIG. 7 illustrates an embodiment is discussed in connection with PDCCH transmission;

FIG. 8 illustrates an embodiment of a PDCCH transmitter;

FIG. 9 illustrates aggregation levels defining search spaces; and

FIG. 10 illustrates a common search space.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a mobile device. A mobile device can also be called, and may contain some or all of the functionality of a system, subscriber unit, subscriber station, mobile station, mobile, wireless terminal, node, device, remote station, remote terminal, access terminal, user terminal, terminal, wireless communication device, wireless communication apparatus, user agent, user device, or user equipment (UE). A mobile device can be a cellular telephone, a cordless telephone, a Session Initiation Protocol (SIP) phone, a smart phone, a wireless local loop (WLL) station, a personal digital assistant (PDA), a laptop, a handheld communication device, a handheld computing device, a satellite radio, a wireless modem card and/or another processing device for communicating over a wireless system. Moreover, various aspects are described herein in connection with a base station. A base station can be utilized for communicating with wireless terminal(s) and can also be called, and may contain some or all of the functionality of, an access point, node, Node B, e-NodeB, e-NB, or some other network entity.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The word “exemplary” is used herein to mean serving as an example, instance, or illustration. Any aspect or design described herein as “exemplary” is not necessarily to be construed as preferred or advantageous over other aspects or designs.

Additionally, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

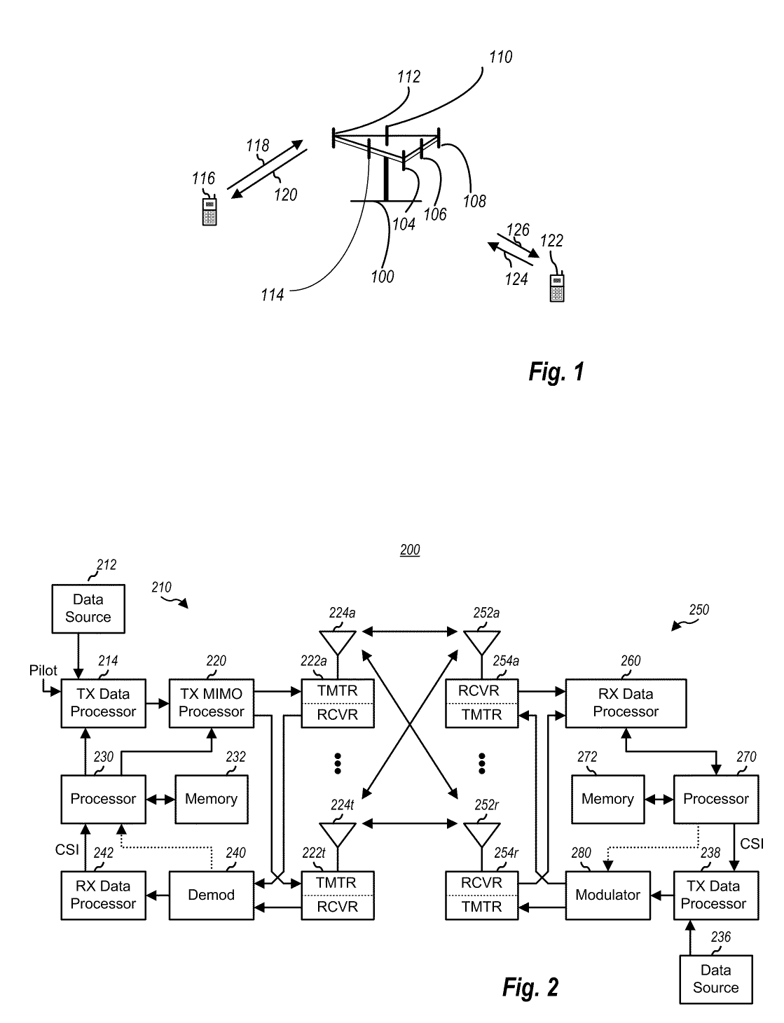

Referring now to FIG. 1, an illustration of a wireless multiple-access communication system is provided in accordance with various aspects. In one example, an access point 100 (AP) includes multiple antenna groups. As illustrated in FIG. 1, one antenna group can include antennas 104 and 106, another can include antennas 108 and 110, and another can include antennas 112 and 114. While only two antennas are shown in FIG. 1 for each antenna group, it should be appreciated that more or fewer antennas may be utilized for each antenna group. In another example, an access terminal 116 can be in communication with antennas 112 and 114, where antennas 112 and 114 transmit information to access terminal 116 over forward link 120 and receive information from access terminal 116 over reverse link 118. Additionally and/or alternatively, access terminal 122 can be in communication with antennas 106 and 108, where antennas 106 and 108 transmit information to access terminal 122 over forward link 126 and receive information from access terminal 122 over reverse link 124. In a frequency division duplex system, communication links 118, 120, 124 and 126 can use different frequency for communication. For example, forward link 120 may use a different frequency then that used by reverse link 118.

Each group of antennas and/or the area in which they are designed to communicate can be referred to as a sector of the access point. In accordance with one aspect, antenna groups can be designed to communicate to access terminals in a sector of areas covered by access point 100. In communication over forward links 120 and 126, the transmitting antennas of access point 100 can utilize beam-forming in order to improve the signal-to-noise ratio of forward links for the different access terminals 116 and 122. Also, an access point using beam-forming to transmit to access terminals scattered randomly through its coverage causes less interference to access terminals in neighboring cells than an access point transmitting through a single antenna to all its access terminals.

An access point, e.g., access point 100, can be a fixed station used for communicating with terminals and can also be referred to as a base station, a Node B, an evolved Node B (eNodeB), an access network, and/or other suitable terminology. In addition, an access terminal, e.g., an access terminal 116 or 122, can also be referred to as a mobile terminal, user equipment, a wireless communication device, a terminal, a wireless terminal, and/or other appropriate terminology.

FIG. 2 is a block diagram of an embodiment of a transmitter system 210 (also known as the access point, base station and eNodeB) and a receiver system 250 (also known as access terminal and user equipment) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beam-forming weights to the symbols of the data streams and to the antenna from which the symbol is being transmitted.

Each transmitter 222 receives and processes a respective symbol stream to provide one or more analog signals, and further conditions (e.g., amplifies, filters, and up-converts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and down-converts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, de-interleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beam-forming weights then processes the extracted message.

In accordance with one or more aspects and corresponding disclosure thereof, various aspects are described in connection with providing a reliability metric, based on output of a decoder module, associated with each possible hypothesis associated with blind decoding that aids a pruning process by rejecting unreliable CRC-passed hypotheses. More particularly, a Physical Downlink Control Channel (PDCCH) carries scheduling assignments and other control information. As location, size, and CRC masking associated with Downlink Control Information (DCI) are not known to a receiver (Rx), blind decoding over possible hypotheses (which could be more than 100) should be performed. The complex structure of PDCCH blind decoding results in increasing false alarm(s) (e.g., the wrong hypothesis selection rate); thus, design of intelligent rules for pruning the decoding results is desirable. Accordingly, unreliable CRC-passed hypotheses are rejected as a function of respective reliability metric based on output of the decoder module. The pruning rules are defined for decoding downlink packets. In particular, a reliability metric is provided for each of possible decoding hypotheses based on an output of the decoder module. Thus, for example, CRC-passed hypotheses are further pruned according to the metric to provide for increased accuracy (e.g., fewer false alarms) in decoding downlink communications.

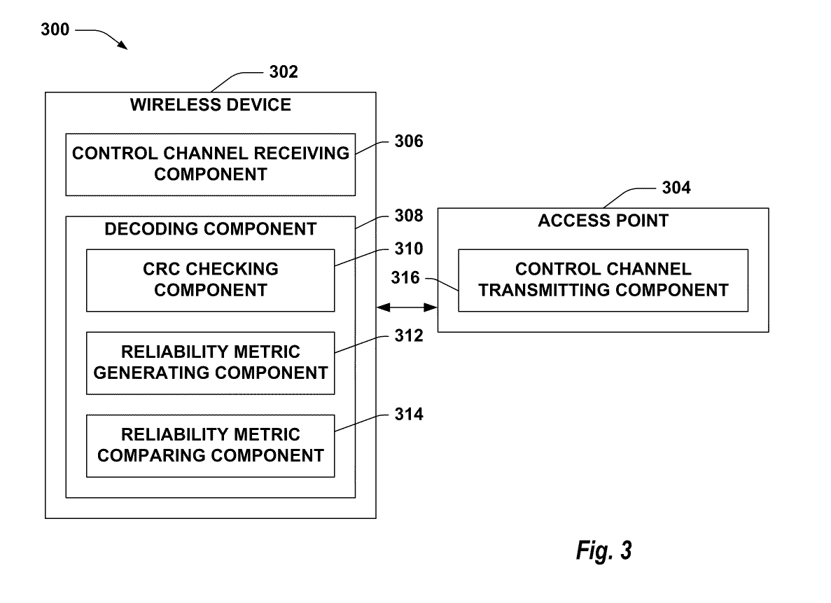

FIG. 3 illustrates a system 300 that facilitates blindly decoding downlink communications in a wireless network based on determining reliability of decoding hypotheses. System 300 includes a wireless device 302, which can be a mobile device, user equipment, access point, a portion thereof, or substantially any device that receives wireless network access from access point 304. Access point 304 can be a base station, eNodeB, femtocell access point, picocell access point, relay node, mobile base station, mobile device operating in a peer-to-peer communications modes, and/or the like, for example. In addition, though the concepts are shown and described in terms of downlink communications, it is to be appreciated that the concepts can be utilized in connection with uplink or substantially any type of communications as well.

Wireless device 302 can comprise a control channel receiving component 306 that obtains communications transmitted over a control channel and a decoding component 308 that decodes transmissions received over the control channel at least in part by trying multiple decoding hypotheses to decode the data. Decoding component 308 includes a CRC checking component 310 that verifies CRC of each decoding hypothesis for a communication to determine which hypotheses pass the CRC, a reliability metric generating component 312 that determines a reliability metric for each decoding hypothesis that passes the CRC, and a reliability metric comparing component 314 that evaluates one or more reliability metrics to determine a hypothesis to decode received control data. Access point 304 can comprise a control channel transmitting component 316 that transmits control data over a control channel in a wireless network.

According to an example, control channel transmitting component 316 can transmit control signals over a set of resources corresponding to control channels in a wireless network specification. The control signals can represent control data that is encoded, scrambled, modulated, etc. Control channel receiving component 306 can obtain the control signals over the resources, and in one example, can demodulate, descramble, etc. the data. Decoding component 308 can decode the control data for subsequent utilization by the wireless device 302. For example, decoding component 308 can blindly decode the control data according to various known encoding schemes having differing aggregation levels. Each blind decoding attempt can be referred to as a hypothesis. In addition, the encoding schemes can be known to the wireless device 302 based on hardcoding, receiving a network specification or configuration, and/or the like.

In one example, decoding component 308 can apply the decoding hypotheses to received data, and the CRC checking component 310 can acquire the CRC portion of the data and test the data against the CRC to determine whether the CRC is valid for the decoding generated by each hypothesis. For hypotheses satisfying CRC, reliability metric generating component 312 can compute a reliability metric for the given hypothesis, such as a maximum likelihood metric, soft correlation metric, hard correlation metric, average output log-likelihood ratio metric, minimum output log-likelihood ratio metric, and/or the like, as described infra. In one example, the reliability metric generating component 312 can compute reliability metrics for the hypotheses at least in part by comparing an initial and final state of a multiple state decoding scheme, such as a fixed window iterative Viterbi algorithm for the given hypothesis. Where the stages are not matched, a reliability is associated with the hypothesis based on the degree of mismatch. It is to be appreciated that the reliability metric can correspond to one or more observed aspects of applying a given decoding hypothesis.

Once reliability metrics are generated for the multiple hypotheses that satisfy CRC for decoding received control data, reliability metric comparing component 314 can compare the metrics to determine which hypothesis to use in decoding the data. In one example, the reliability metric comparing component 314 can select the hypothesis with the highest reliability metric, computed as described above. In another example, reliability metric comparing component 314 can select a hypothesis with a highest reliability metric out of those having a CRC over a predefined threshold to further reduce the number of false alarms. For example, the threshold can be defined in a specification, received from one or more network components, a configuration, and/or the like. In this regard, further pruning of decoding hypotheses is provided by evaluating CRC-passed hypotheses to determine a reliability metric, and comparing the metrics to select a hypothesis for decoding the data. Adding this additional functionality, as described, can decrease the frequency of false alarm decoding. Moreover, it is to be appreciated, in one example, that the reliability metric can be computed and compared before performing CRC.

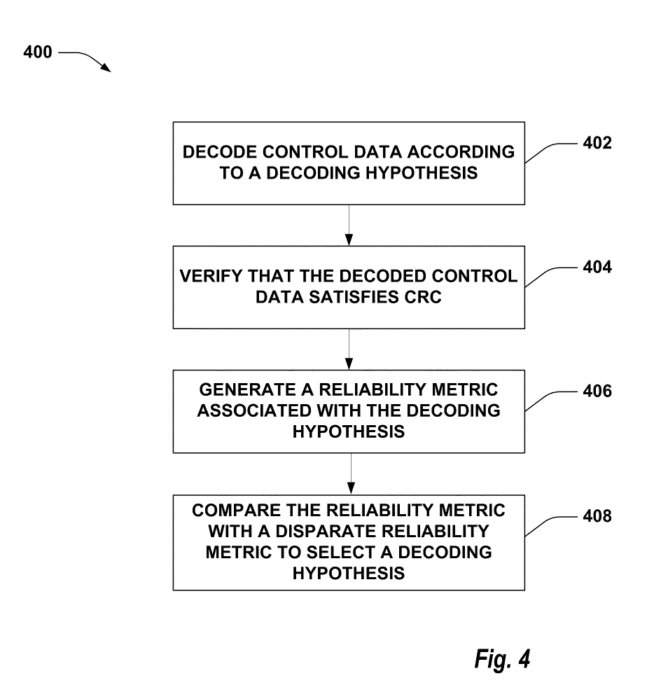

FIG. 4 illustrates a methodology 400 for creating and comparing reliability metric for decoding hypotheses to select a hypothesis for decoding received data. At 402, control data can be decoded according to a decoding hypothesis. The control data, as described, can be received from an access point and can comprise scheduling assignments, or other control data. At 404, it can be verified that the decoded control data satisfies CRC. CRC information can be received in the control data and retrieved upon decoding the control data according to the decoding hypothesis. The CRC information can be checked against the decoded data to determine whether the CRC is satisfied. If so, a reliability metric can be generated and associated with the decoding hypothesis at 406. As described, the reliability metric can relate to a plurality of decoding phases of the control data. If the phases differ, for example, the reliability metric can be generated as indicative of the difference. At 408, the reliability metric can be compared with a disparate reliability metric to select a decoding hypothesis. As described, a hypothesis with a highest metric can be selected. In another example, only metrics relating to hypothesis with a CRC at a threshold level are considered.

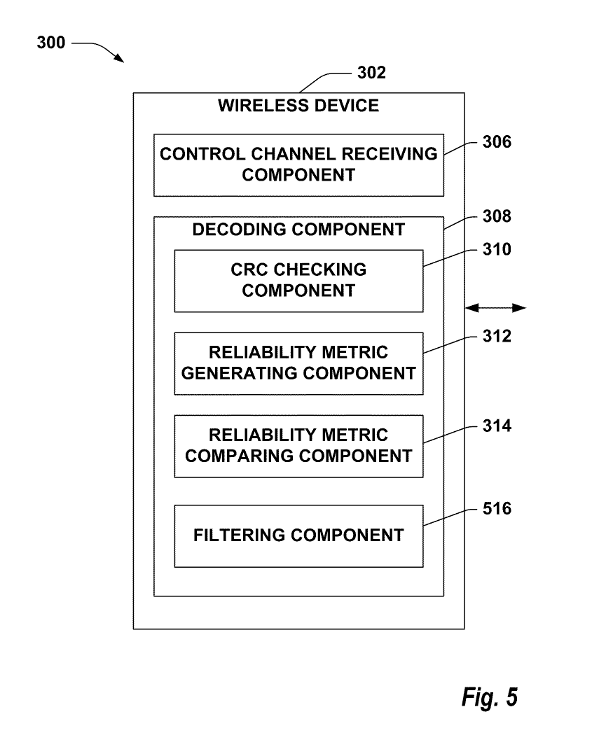

FIG. 5 illustrates another embodiment of system 300 that includes a filter component 516 that can be employed in connection with pruning undesirable decoding hypotheses by evaluating CRC-passed hypotheses to determine a reliability metric, and comparing the metrics to select a suitable hypothesis for decoding the data.

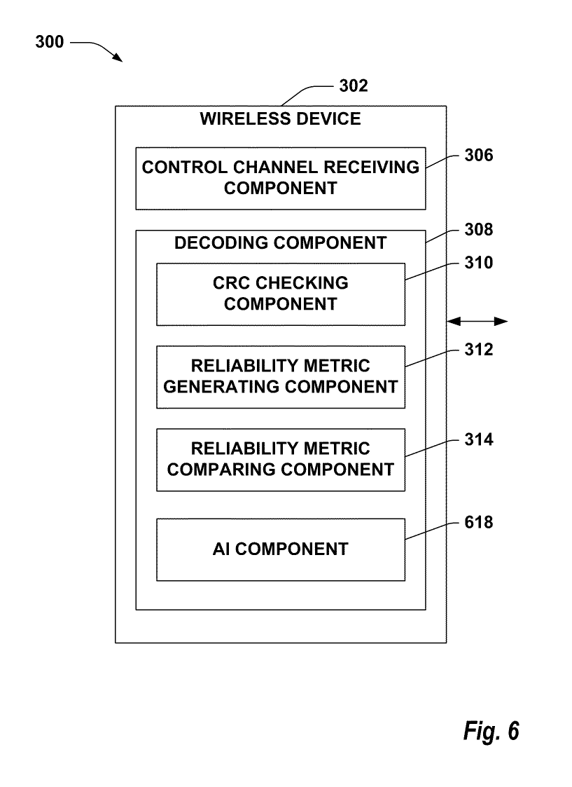

FIG. 6 illustrates yet another embodiment of system 300 that includes an artificial intelligence (AI) component 618 that can facilitate pruning undesirable decoding hypotheses in accordance with the embodiments described herein. The AI component 618 can optionally utilize in part inference based schemes to facilitate inferring intended actions to be performed at a given time and state. The AI-based aspects of the invention can be effected via any suitable machine-learning based technique and/or statistical-based techniques and/or probabilistic-based techniques. For example, the use of expert systems, fuzzy logic, support vector machines, greedy search algorithms, rule-based systems, Bayesian models (e.g., Bayesian networks), neural networks, other non-linear training techniques, data fusion, utility-based analytical systems, systems employing Bayesian models, etc. are contemplated and are intended to fall within the scope of the hereto appended claims.

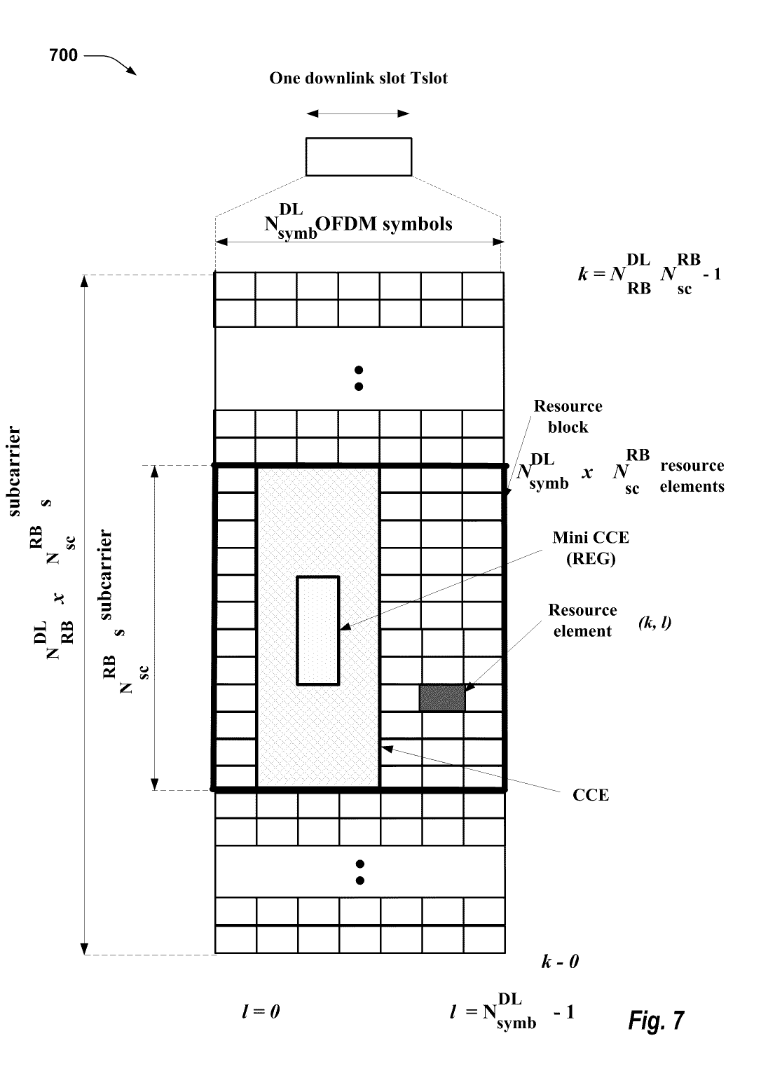

Referring now to FIG. 7, an embodiment 700 is discussed in connection with PDCCH transmission. On each sub-frame, a physical control channel is transmitted on an aggregation of one or several consecutive control channel elements (CCEs), where a control channel element corresponds to 9 Resource Element Groups (REG) also called mini-CCE. PDCCH takes the first N OFDM symbols of each sub-frame, where N is equal to a value that a physical control format indicator channel (PCFICH) carries. If the number of resource blocks in system bandwidth is equal to or less than 10, the possible N values are 2, 3, or 4. Otherwise, N can be 1, 2, or 3. In the PDCCH symbols, the tones over the entire bandwidth except for reference signal (RS), PCFICH, and Physical HARQ Indicator Channel (PHICH) tones can be used for PDCCH transmission, which can be called a control region. FIG. 7 illustrates a CCE with its REGs.

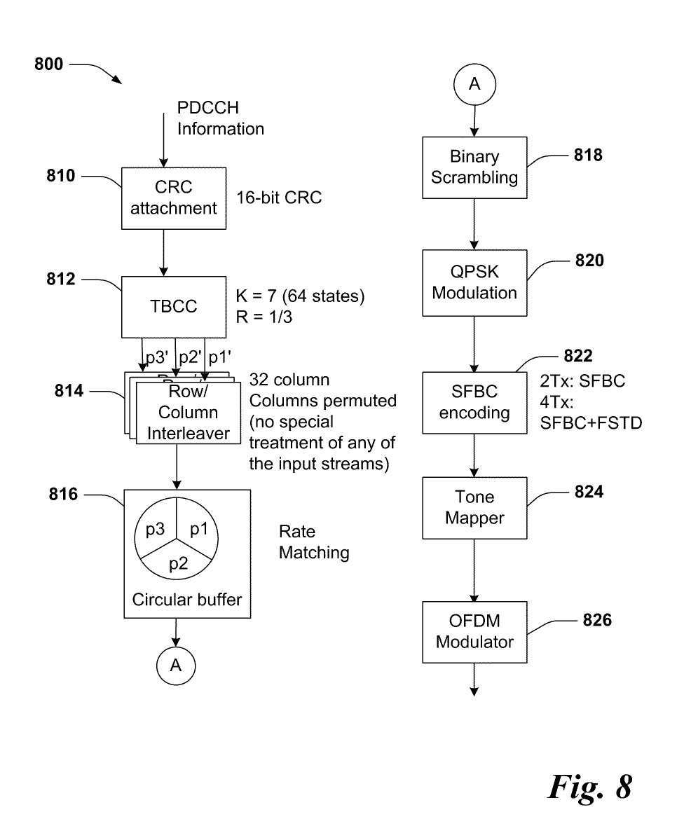

FIG. 8 shows a block diagram of a PDCCH transmitter 800. A 16-bit CRC 810 is computed from given PDCCH information bits and then CRC masking is performed by applying corresponding 16-bit radio network temporary identifier (RNTI) values. After the CRC attachment, the combined bits are encoded based on Tail Biting convolutional Code (TBCC) 812 with K=7, rate=1/3. After a 32-column interleaving operation 814, rate matching 816 is performed by using a circular buffer to implement repetition coding, and then binary scrambling 818 and quadrature phase-shift keying (QPSK) modulation 820 are performed. With 2 or 4 transmit antennas, space-frequency block-coded (SFBC) or space-frequency block-coded with frequency switched transmit diversity (SFBC-FSTD) encoding 822 is, respectively, added and the symbol sequence is finally mapped 824 to corresponding tones in a control region and through an OFDM modulator 826. The tone mapping operation for PDCCH is rather complicated since multiple PDCCHs with different aims can be concurrently sent on each subframe, and REG level interleaving is performed in order to achieve better diversity effects.

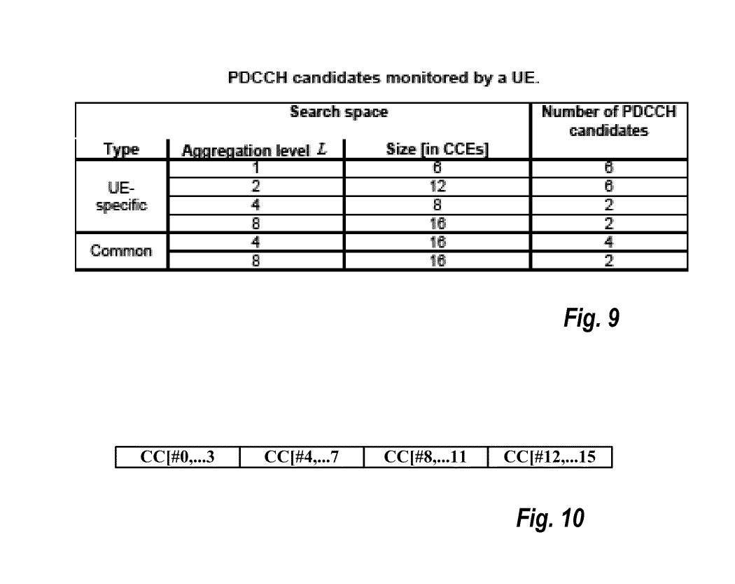

With respect to PDCCH Blind Decoding, the control region consists of a set of CCEs in each subframe. A UE shall decode a set of PDCCH candidates for control information in every non-DRX subframe. The set of PDCCH candidates are defined in terms of search spaces. The UE shall monitor one common search space at each of the aggregation levels 4 and 8 and one UE-specific search space at each of the aggregation levels 1, 2, 4, 8. The common and UE-specific search spaces may overlap. Aggregation levels defining the search spaces are listed in FIG. 9.

Therefore, in order to decode the correct PDCCH, a receiver needs to go through all possible hypotheses via blind decoding procedure. As mentioned above, for the common search space, there are 4 different candidates with 4-CCE aggregation level, and 2 different candidates with 8-CCE level. In addition, two possible PDCCH payload sizes can be employed for PDCCHs in the common search space: one for DCI format 0/1A/3/3A, and the other for DCI format 1C. Therefore, in the common search, there are 2×(4+2)=12 hypotheses to be tested.

On the other hand, in the UE specific search space, 1, 2, 4, or 8 CCE aggregation levels are all feasible, and each have 6, 6, 2, 2 candidate locations. Also, with any given transmission mode, the PDCCHs in the UE specific search space can take two different payload sizes: one for DCI format 1A, and the other one for DL grant (DCI format 1/1B/1D/2/2A) where only one of these five formats can be active for each transmission mode. Therefore, the number of decoding hypotheses for the UE specific search space is 2×(6+6+2+2)=32, and including the common search space, there are 44 blind decoding hypotheses to be tested on each sub-frame.

In addition, for each decoded payload, CRC computation is performed to check whether it is the correct payload or not. Before computing CRC, a CRC de-masking operation with certain RNTI values is performed to remove an RNTI mask imposed at the transmitter.

In connection with Pruning PDCCH Blind Decoding Results, in the event that PDCCH blind decoding generates multiple CRC passes, it is desirable to prune results such that suitable ones are selected. False alarm events in PDCCH decoding can harm DL/UL data transmission and UE/eNB procedures, and a large number of hypotheses may drastically increase the false alarm rate. With 16 bit CRC, it can be expected to have one false CRC pass in every 2̂16−1=65535 CRC computations. Since there are around 100 CRC computations per sub-frame, a false alarm can happen in every 600˜700 sub-frames (0.6˜0.7 seconds). Therefore, having carefully designed pruning rules is desirable for system performance. It is aimed to further reduce the number of false alarms with the aid of reliability metric associated with output of aTBCC decoder. Basically, the CRC-passed hypotheses with low reliability metric are rejected. It is noted that this reliability-aided pruning can be performed before or after applying other pruning rules. It is readily apparent that the number of comparisons in this scheme is reduced if it is done after applying other rules.

Reliability-Aided Pruning Notations

Here, parameters employed in this description are defined. In the following L denotes the payload size in bits including CRC. BPSK modulation is also assumed i.e., 0→−1 and 1→1. QPSK modulation is employed for PDCCH transmission. However, after LLR calculation, the system can be analyzed with BPSK modulation assumption.

The input to the TBCC decoder (TBCC DEC) is a noisy codeword \vec{Y}={y₀, y₁, . . . , y_{3L-1}} with elements yᵢ=xᵢ+nᵢ for iε{0, 1 . . . , 3L−1}. The codeword element xᵢ is either 1 or −1. The Gaussian noise element nᵢ has variance

$${σ}_{i}^{2} = \frac{{σ}^{2}}{{\vert {h}_{i} \vert}^{2}} ,$$

where |hᵢ| is the channel magnitude associated with bit position i, and a σ² is the noise variance if |hᵢ|=1.

The corresponding input LLR vector to TBCC DEC is: \vec{LLR}={llr₀, llr₁, . . . , llr_{3L-1}}, where

$${llr}_{i} = \frac{4}{{σ}_{i}^{2}} {y}_{i} .$$

The estimated codeword and message are respectively denoted by: \vec{X}={x₀, x₁, . . . , x_{3L-1}}, and \vec{D}={d₀, d₁, . . . , d_{L-1}}. In this discussion it is assumed that channel and interference estimations are perfect.

TBCC Decoding

Here, a Fixed Window Iterative Viterbi Algorithm (FW-IVA) introduced in is considered. In this decoding scheme, a received signal is replicated N=3 times and Viterbi decoding is applied to the extended received signal, with equally likely initial state metrics. A decoded codeword is declared in the mid section of the most likely path. Therefore, all the considered metrics should be calculated for the mid section of the most likely path.

It is noted that due to the nature of TBCC, initial and final states in a most likely (survivor) path should be the same. In this decoding scheme if these states (for the mid-section) are not matched, a small reliability is associated to output of the decoder. There may be some cases (especially in low SNR) that the decoded message is correct but the states are not matched and by associating a small reliability to the hypothesis the probability of miss detections of the correct hypothesis is increased. The number of these cases is small and decreases as the SNR increases. Extensive simulation results indicate that the number of these cases is small.

Reliability Metrics

To find an appropriate metric, different suggestions with different complexities are considered. Assume there are K hypotheses to test. Associated with each hypothesis kε{1, . . . , K} with length L^{(k)} are the input LLR \vec{LLR}={llr₀^{(k)}, llr₁^{(k)}, . . . , llr_{3L}_{^{(k)}}₋₁^{(k)}} to the decoder, the estimated codeword {right arrow over (\hat{X}^{(m)}={\hat{x}₀^{(m)}, \hat{x}₁^{(m)}, . . . , \hat{x}_{3L}_{^{(m)}}₋₁^{(m)}} after the decoding, and the noise standard deviation vector {σ₀^{(m)}, σ₁^{(m)}, . . . , σ_{3L}_{^{(m)}}₋₁^{(m)}}.

Maximum Likelihood Metric (MLM)

Viterbi decoder essentially selects a maximum likelihood estimation of the codeword, i.e.

$${X}^{\vec{\hat{}}} = arg {max}_{i} P ( \vec{Y} \vert {{X}^{\vec{\hat{}}}}_{i} ) .$$

For comparing different hypotheses the natural logarithm of this probability is utilized as a metric.

$${M}_{1}^{( k )} = {\sum }_{i = 0}^{3 {L}^{( k )} - 1} ( log ( 2 {πσ}_{i}^{k} ) - \frac{{σ}_{i}^{2 ( k )}}{32} {\vert {llr}_{i}^{( k )} - \frac{4}{{σ}_{i}^{2 ( k )}} {\hat{x}}_{i}^{( k )} \vert}^{2} )$$

We could similarly define Maximum a posteriori metric based on P({circumflex over (\vec{X}ᵢ|\vec{Y}) However, calculating this metric with current structure of the Viterbi decoder is not feasible.

Soft Correlation Metric (SCM)

For BPSK (or any constant amplitude) modulation and Gaussian noise, it is easy to show that

$${X}^{\vec{\hat{}}} = arg {max}_{i} P ( \vec{Y} \vert {{X}^{\vec{\hat{}}}}_{i} )$$

is equivalent to maximizing the correlation metric

$${arg max}_{i} {\sum }_{i = 0}^{3 L} {llr}_{i} {\hat{x}}_{i} .$$

We use the normalized correlation metric of the hypothesis.

$${M}_{2}^{( k )} = \frac{1}{\sqrt{3 {L}^{( k )} {\sum }_{i = 0}^{3 {L}^{( k )} - 1} {\vert {llr}_{i}^{( k )} \vert}^{2}}} {\sum }_{i = 0}^{3 {L}^{( k )} - 1} {llr}_{i}^{( k )} {\hat{x}}_{i}^{( k )}$$

Hard Correlation Metric (HCM)

By defining

$$sgn ( x ) = \{ \begin{matrix}1 & x \geq 0 \\ - 1 & x < 0 ,\end{matrix}$$

a hard correlation metric can be defined as

$${arg max}_{i} {\sum }_{i = 0}^{3 L} sgn ( {llr}_{i} ) sgn ( {\hat{x}}_{i} ) .$$

Then the normalized version is:

$${M}_{3}^{( k )} = \frac{1}{3 {L}^{( k )}} {\sum }_{i = 0}^{3 {L}^{( k )} - 1} sgn ( {llr}_{i}^{( k )} ) sgn ( {\hat{x}}_{i}^{( k )} )$$

Average Output LLR Metric (AOLM)

If the decoder is able to provide soft-outputs instead of {right arrow over (\hat{X}. For instance, if BCJR or SOVA (soft Output Viterbi Algorithm) decoder is used instead of the Viterbi decoder, then the soft output of the decoder, i.e. the LLR calculated for decoded information bits, represented by llroutᵢ^{(k)} and the decoded bits both have the same sign (meaning that if the decoded bit is zero, the associated llrout is negative and if the decoded bit is one, the associated llrout is positive). The normalized AOLM is defined as:

$${M}_{4}^{( k )} = \frac{1}{\sqrt{{L}^{( k )} {\sum }_{i = 0}^{{L}^{( k )} - 1} {\vert {llrout}_{i}^{( k )} \vert}^{2}}} {\sum }_{i = 0}^{{L}^{( k )} - 1} \vert {llrout}_{i}^{( k )} \vert$$

M₄^{(k)} is somehow similar to M₂^{(k)} in that both represent a correlation between the LLR vectors and the output vector. However, input LLRs are used in SCM and the metric calculation is done over the codeword with length 3L^{(k)}. In AOLM, output LLRs are utilized and the metric calculation is done over the decoded information bits with length L^{(k)}.

Minimum Output LLR Metric (MOLM)

The first L-16 decoded bits are sent to CRC check block for computing parity bits. Then the computed parity bits are XORed with the last 16 bits of decoded information bits. The first L-16 decoded bits are independent. A simplified LLR algebra proposed in Iterative decoding of binary block and convolutional codes, IEEE Info. Theory, 1996 states that the LLR associated with the XOR operation of two independent bits is almost equal to the minimum of the LLRs corresponding to those bits. Considering the fact that the parity bits are computed based on the XOR operation over the information bits, the MOLM is defined as:

$${M}_{5}^{( k )} = {min}_{i ∈ \{ 0 , … , L - 17 \}} \vert {llrout}_{i}^{( k )} \vert$$

Assuming all decoded bits are independent (although not precise), another variant of MOLM, called MOLM-ALL is defined as:

$${M}_{6}^{( k )} = {min}_{i ∈ \{ 0 , … , L - 1 \}} \vert {llrout}_{i}^{( k )} \vert$$

Decision Rule for Pruning

Having the reliability metrics defined, it is now possible to decide on hypotheses based on their corresponding reliabilities.

Decision Rule for the Baseline Pruning Algorithm

A Baseline (BL) system that experimental results are compared with, does not use reliability metric and when some hypotheses pass CRC it selects the one with highest aggregation level, i.e., SNR. In the simulation, the hypothesis with higher SNR is translated to the one with higher

$$\frac{1}{\sqrt{3 {L}^{( k )} {\sum }_{i = 0}^{3 {L}^{( k )} - 1} {\vert {llr}_{i}^{( k )} \vert}^{2}}} {\sum }_{i = 0}^{3 {L}^{( k )} - 1} \vert {llr}_{i}^{( k )} \vert$$

If all aggregation levels are the same, it selects one of the hypotheses randomly.

Decision Rule for the Proposed Pruning Algorithm

Two decision rules can be used:

Decision Rule without Thresholding

In this scheme, amongst the CRC-passed hypotheses, the hypothesis with highest reliability metric is selected.

Decision Rule with Thresholding

In this scheme, amongst the CRC-passed hypotheses which are above a predefined threshold, the hypothesis with highest reliability metric is selected. Defining this threshold further reduces the number of false alarms. However, it might lead to miss detection of the correct hypothesis which is elaborated later.

Evaluation Parameters

In this section some parameters are defined that are referred to in simulations. Without loss of generality it is assumed that the message m is transmitted using hypothesis l, denoted by h(l). After blind decoding and CRC check, if hypothesis k is selected it is shown by ĥ(k). If a hypothesis cannot be selected, for instance if all CRC checks fail or if all reliabilities are less than a threshold, a NACK signal is declared and shown that by ĥ(?). The following parameters are defined:

P_{FA}=P(ĥ(k)|h(l)),k≠l

P_{MD}=P(\hat{m}=m,ĥ(?)|h(l))

P_{SUCCESS}=P(\hat{m}=m,ĥ(l)|h(l))

P_{PER}=P(\hat{m}≠m,ĥ(l)|h(l))

P_{FER}=(\hat{m}≠m|h(l))

P_{NACK}=P(ĥ(?)|h(l))

Performance Evaluation

Wrong Hypothesis Modeling

The purpose of this modeling is to avoid doing simulations in EFSIM in the initial study while keeping PDCCH processing as accurate as possible. In this description, pruning over common search space is only considered as it corresponds to fewer possibilities.

FIG. 10 shows a common search space. As mentioned earlier there exist 4 different candidates with 4-CCE aggregation level, and 2 different candidates with 8-CCE level. In addition, two possible PDCCH payload sizes can be used for PDCCHs in the common search space leading to 12 possible hypotheses. In this description, the correct hypothesis is only tested against one wrong hypothesis. It can be seen that in the case of multiple wrong hypotheses our proposed scheme will reject more false alarms.

For the purpose of this discussion, only TBCC decoder and CRC check blocks are considered. The effect of rate marching block is absorbed in difference in SNR. For simplicity of simulations, it is assumed that the CCE sizes are in such a way that a multiple of the payload size can fit into the corresponding CCEs. It should be mentioned that this assumption does not change the performance of the system too much—it is simply for having a same SNR over the codeword. Different possibilities are explained in the following.

Same Aggregation Level and Payload Size but Different Location

In this case, the difference between the hypotheses is the location. It is stressed that the two hypotheses do not overlap in this situation. In this case, the wrong hypothesis is either noise or noise and interference.

Scenario 1: Noise only

Scenario 2: Noise and interference

Same Location and Payload Size but Different Aggregation Level

It is noted that if the correct hypothesis has been allocated the larger aggregation level and the wrong one has been assumed to have smaller aggregation level, even the wrong hypothesis would have been useful to decode (It has had 3 dB lower SNR). Because of the cyclic shift in the mini-CCE de-shuffling which is aggregation level dependent, this case can also be assumed to have the same structure as scenario 2 but with 3 dB smaller SNR. It is called scenario 3.

Same Aggregation Level and Location but Different Payload Size

For simplicity of simulations it is assumed that the wrong hypothesis has the payload size twice the right hypothesis. Mini-CCE de-shuffling does not change anything as it is aggregation level dependent. The effect of sub-block interleaver can be considered as a combination of randomly interleaved version of the signal plus noise. It should be mentioned that due to the rate-dematching block the wrong hypothesis has 3 dB smaller SNR compared to the right hypothesis. This scenario is called scenario 4. Basically scenario 4 is the same as scenario 2 but with 3 dB smaller SNR and the input sequence to TBCC DEC has twice the length of scenario 2.

Different Location

When the hypotheses do not overlap, scenario 1 and scenario 2 with different powers and SNR can happen.

Same Location but Different Payload Size and Aggregation Level

In this case the wrong hypothesis is like scenario 4 but with 3 dB smaller SNR. This scenario is referred to as scenario 5.

Simulation Results

Initial simulation results for AWGN channel indicate that AOLM and MOLM metrics can reduce number of false alarms about 50% (with BCJR decoder instead of TBCC DEC) compared to SCM and HCM. Implementing AOLM and MOLM with SOVA, a less complex decoder than BCJR, however does not provide an improvement compared to SCM and HCM. MLM is also complex as it does require noise powers in every tone and therefore ignored. Therefore, SCM and HCM are considered in the following as they provide a good result with slight changes to the current TBCC DEC. Extensive simulations indicate that the general trend of the results are similar for different simulation scenarios and therefore, here the results for scenario 3 is presented.

AWGN Simulation Results

For this scenario, all the resource elements are assumed to have the same channel gain of 1.

The Effect of State-Mismatch

In this section the false alarm rate of the BL system is analyzed with and without state mismatch for the four discussed scenarios. For analyzing each scenario, payload size of 29 is considered.

To be able to run extensive simulation results for covering different scenarios and situations, the number of CRC bits are reduced. The effect of increasing CRC length has also be considered in the analysis.

24 bit data+5 bit CRC (Scenario 3)

In 40000 transmissions:

| | SNR = −4 dB | SNR = −3 dB | SNR = −2 dB |
|---|---|---|---|
| BL system | | | |
| FA | 461 | 318 | 198 |
| MD | 318 | 288 | 190 |
| BL system | | | |
| with State | | | |
| Check | | | |
| FA | 204 | 135 | 91 |
| MD | 140 | 121 | 91 |

21 bit data+8 bit CRC

In 300000 transmissions:

| | SNR = −4 dB | SNR = −3 dB | SNR = −2 dB |
|---|---|---|---|
| BL system | | | |
| FA | 438 | 306 | 193 |
| MD | 307 | 278 | 189 |
| BL system | | | |
| with State | | | |
| Check | | | |
| FA | | 131 | 82 |
| MD | | 119 | 81 |

It is remarked that by increasing the CRC length while keeping the total length fixed, the number of false alarms will decrease exponentially by the length of CRC as expected. For instance, the number of false alarms for SNR=−2 dB for 5-bit CRC is almost 8 times of the number for 8-bit CRC.

The Effect of Reliability SCM

From now on, for capturing the gain of reliability metric, it is assumed that the BL system is equipped with state mismatch check unit.

24 bit data+5 bit CRC (Scenario 3)

In 40000 transmissions:

The number of false alarms and miss detections in terms of the threshold values are shown in the tables below. Zero threshold is basically equivalent to the decision-rule.

| | 0 | .1 | .2 | .3 | .4 | .5 | .6 | .7 | .8 | .9 | 1 |
|---|---|---|---|---|---|---|---|---|---|---|---|
| SCM, | | | | | | | | | | | |
| SNR = −4 dB | | | | | | | | | | | |
| FA | 74 | 77 | 79 | 65 | 65 | 69 | 27 | 0 | 0 | 0 | 0 |
| MD | 84 | 81 | 86 | 75 | 82 | 72 | 864 | 23686 | 34355 | 34484 | 34460 |
| SCM, | | | | | | | | | | | |
| SNR = −3 dB | | | | | | | | | | | |
| FA | 23 | 23 | 21 | 15 | 26 | 17 | 6 | 0 | 0 | 0 | 0 |
| MD | 25 | 21 | 23 | 20 | 24 | 11 | 171 | 14795 | 37750 | 38321 | 38327 |

This study suggests that the SCM is fairly stable with respect to threshold (up to threshold of 0.5) over the range of SNR. For simplicity one can just use the decision rule [0076] without setting a threshold and just picking up the hypothesis with highest reliability.

21 bit data+8 bit CRC (Scenario 3)

In 300000 transmissions:

| | 0 | .1 | .2 | .3 | .4 | .5 | .6 | .7 | .8 | .9 | 1 |
|---|---|---|---|---|---|---|---|---|---|---|---|
| SCM, | | | | | | | | | | | |
| SNR = −4 dB | | | | | | | | | | | |
| FA | 66 | | | 73 | | | 25 | | | | |
| MD | 514 | | | 522 | | | 6124 | | | | |
| SCM, | | | | | | | | | | | |
| SNR = −3 dB | | | | | | | | | | | |
| FA | 20 | | | 14 | | | 5 | | | | |
| MD | 123 | | | 145 | | | 1228 | | | | |

The Effect of Reliability HCM

24 bit data+5 bit CRC (Scenario 3)

In 40000 transmissions:

| | 0 | .1 | .2 | .3 | .4 | .5 | .6 | .7 | .8 | .9 | 1 |
|---|---|---|---|---|---|---|---|---|---|---|---|
| HCM, | | | | | | | | | | | |
| SNR = −4 dB | | | | | | | | | | | |
| FA | 132 | 125 | 129 | 137 | 151 | 116 | 32 | 1 | 0 | 0 | 0 |
| MD | 117 | 125 | 131 | 127 | 153 | 1016 | 8960 | 24672 | 33905 | 34314 | 34538 |
| HCM, | | | | | | | | | | | |
| SNR = −3 dB | | | | | | | | | | | |
| FA | 40 | 38 | 44 | 49 | 55 | 42 | 14 | 0 | 0 | 0 | 0 |
| MD | 36 | 38 | 45 | 55 | 45 | 320 | 4236 | 18501 | 35961 | 38261 | 38265 |

| | | | | | | | | | | |
|---|---|---|---|---|---|---|---|---|---|---|
| 0 | .1 | .2 | .3 | .4 | .5 | .6 | .7 | .8 | .9 | 1 |

| | | | |
|---|---|---|---|
| HCM, | | | |
| SNR = −4 | | | |
| dB | | | |
| FA | | 121 | 129 |
| MD | | 543 | 7273 |
| HCM, | | | |
| SNR = −3 | | | |
| dB | | | |
| FA | 46 | 38 | 32 |
| MD | 157 | 139 | 2193 |

21 bit data+8 bit CRC

It is shown that number of false alarms can be reduced by analyzing the output of TBCC DEC in two ways: (1) rejecting hypotheses with state-mismatch at TBCC DEC output; or (2) selecting the hypothesis with highest reliability (according to different metrics) in the case of having multiple hypotheses passing CRC check block.

The number of false alarms can be further reduced by rejecting CRC-passed hypotheses below a predetermined threshold. For the analyzed scenario, it is seen that setting threshold to be around 0.5-0.7 for both SCM and HCM reliability metrics, the number of false alarms can be significantly reduced at the cost of increase in the number of miss detections. Comparing the result of SCM and HCM, it can be seen that in scenario 3, SCM provides 50% less false alarms compared to HCM. Both SCM and HCM are easy to implement and require slight changes to the original TBCC DEC.

It is verified by simulations that by increasing CRC length the number of false alarms will decrease (it becomes half for adding 1 bit to CRC length), however the number of miss detections will remain the same. Both SCM and HCM can be calculated outside of the TBCC DEC block using quantized input LLRs to Fixed Point TBCC DEC (FPTBCC DEC) and the output of the FPTBCC DEC.

It should be mentioned that the above simulations are done for AWGN channel as an initial step. It is to be appreciated that the metrics can be applied in EFSIM.

It is to be understood that the aspects described herein may be implemented by hardware, software, firmware or any combination thereof. When implemented in software, the functions may be stored on or transmitted over as one or more instructions or code on a computer-readable medium. Computer-readable media includes both computer storage media and communication media including any medium that facilitates transfer of a computer program from one place to another. Also, the computer-readable media includes non-transitory computer-readable media. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor through various means as is known in the art. Further, at least one processor may include one or more modules operable to perform the functions described herein.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform the functions described herein.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects and/or aspects, it should be noted that various changes and modifications could be made herein without departing from the scope of the described aspects and/or aspects as defined by the appended claims. Accordingly, the described aspects are intended to embrace all such alterations, modifications and variations that fall within scope of the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A method for wireless communication, comprising:
decoding control data according to a decoding hypothesis;
verifying that the decoded control data satisfies a cyclic redundancy check (CRC) according to a CRC portion provided with the control data; and
generating a reliability metric associated with the decoding hypothesis based at least in part on the decoded control data.

2. The method of claim 1, wherein the generating the reliability metric is based at least in part on evaluating a difference in a plurality of decoding stages performed using the decoding hypothesis.

3. The method of claim 2, wherein the generating the reliability metric includes computing a maximum likelihood metric, a soft correlation metric, a hard correlation metric, an average output log-likelihood ratio metric, or a minimum output log-likelihood ratio metric associated with the plurality of decoding stages.

4. The method of claim 1, further comprising:
comparing the reliability metric with at least one disparate reliability metric related to a disparate decoding hypothesis for the control data; and
determining whether to decode the control data with the decoding hypothesis based at least in part on the comparison of the reliability metric to the disparate reliability metric.

5. The method of claim 4, further comprising determining that a disparate CRC related to the disparate decoding hypothesis is above a threshold level.

6. An apparatus for wireless communication, comprising:
at least one processor configured to:
apply a decoding hypothesis to received control data;
discern that the decoding applied control data satisfies a cyclic redundancy check (CRC) according to CRC information provided with the control data; and
create a reliability metric associated with the decoding hypothesis based at least in part on the application of the decoding hypothesis to the control data.

7. The apparatus of claim 6, wherein the at least one processor creates the reliability metric based at least in part on evaluating a plurality of decoding results in a plurality of decoding stages performed on the control data using the decoding hypothesis.

8. The apparatus of claim 7, wherein the at least one processor creates the reliability metric by computing a maximum likelihood metric, a soft correlation metric, a hard correlation metric, an average output log-likelihood ratio metric, or a minimum output log-likelihood ratio metric associated with the plurality of decoding results.

9. The apparatus of claim 6, wherein the at least one processor is further configured to:
compare the reliability metric with at least one disparate reliability metric related to a disparate decoding hypothesis for the control data; and
utilize the decoding applied control data based at least in part on comparing the reliability metric to the disparate reliability metric.

10. The apparatus of claim 9, wherein the at least one processor is further configured to determine that a disparate CRC related to the disparate decoding hypothesis is above a threshold level.

11. An apparatus for wireless communication, comprising:
means for decoding control data according to a decoding hypothesis;
means for verifying that the decoded control data satisfies a cyclic redundancy check (CRC) according to a CRC portion provided with the control data; and
means for generating a reliability metric associated with the decoding hypothesis based at least in part on the decoded control data.

12. The apparatus of claim 11, wherein the means for generating the reliability metric generates the reliability metric based at least in part on evaluating a difference in a plurality of decoding stages performed using the decoding hypothesis.

13. The apparatus of claim 12, wherein the means for generating the reliability metric computes a maximum likelihood metric, a soft correlation metric, a hard correlation metric, an average output log-likelihood ratio metric, or a minimum output log-likelihood ratio metric associated with the plurality of decoding stages to generate the reliability metric.

14. The apparatus of claim 11, further comprising:
means for comparing the reliability metric with at least one disparate reliability metric related to a disparate decoding hypothesis for the control data, wherein the means for decoding control data determines whether to decode the control data with the decoding hypothesis based at least in part on comparing the reliability metric to the disparate reliability metric.

15. The apparatus of claim 14, wherein the means for comprising the reliability metric further determines that a disparate CRC related to the disparate decoding hypothesis is above a threshold level.

16. A computer program product, comprising:
a computer-readable medium, comprising:
code for causing at least one computer to apply a decoding hypothesis to received control data;
code for causing the at least one computer to discern that the decoding applied control data satisfies a cyclic redundancy check (CRC) according to CRC information provided with the control data; and
code for causing the at least one computer to create a reliability metric associated with the decoding hypothesis based at least in part on applying the decoding hypothesis to the control data.

17. The computer program product of claim 16, wherein the code for causing the at least one computer to create the reliability metric further creates the reliability metric based at least in part on evaluating a plurality of decoding results in a plurality of decoding stages performed on the control data using the decoding hypothesis.

18. The computer program product of claim 17, wherein the code for causing the at least one computer to create the reliability metric further creates the reliability metric by computing a maximum likelihood metric, a soft correlation metric, a hard correlation metric, an average output log-likelihood ratio metric, or a minimum output log-likelihood ratio metric associated with the plurality of decoding results.

19. The computer program product of claim 16, wherein the computer-readable medium further comprises code for causing the at least one computer to:
compare the reliability metric with at least one disparate reliability metric related to a disparate decoding hypothesis for the control data; and
utilize the decoding applied control data based at least in part on comparing the reliability metric to the disparate reliability metric.

20. The computer program product of claim 19, wherein the computer-readable medium further comprises code for causing the at least one computer to determine that a disparate CRC related to the disparate decoding hypothesis is above a threshold level.
